(19) United States
(12) Patent Application Publication
(10) Pub. No.: US 2009/0327790 A1
(43) Pub. Date: Dec. 31, 2009

(54) METHOD FOR SYNCHRONIZING A PLURALITY OF DRIVES, AND A DRIVE OPERATED WITH THE METHOD

(75) Inventors: Thomas Götze, Chemnitz (DE); Jürgen Olomski, Herzogenaurach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/491,712

(22) Filed: Jun. 25, 2009

(30) Foreign Application Priority Data
Jun. 26, 2008 (EP) EP08011624.7

(51) Int. Cl. G06F 1/12

(52) U.S. Cl. 713/400

(57) ABSTRACT

In a machine with a supervisory unit and several drives, contour discrepancies can be eliminated and synchronization simplified by using a line which is commonly employed for actuating a drive, e.g. the Enable line, also for synchronously sending a clock pulse to the various coordinated drives operating as “slaves”. The clock pulse representing the synchronization signal has a predetermined duration which is shorter than pulses typically used to deactivate a drive. The drives are designed to distinguish between these two types of pulses and only interpret a pulse of longer duration where the Drive Enable signal is switched off for a longer time, as indicating removal of the Drive Enable, i.e. deactivation of the drive.

### CROSS-REFERENCES TO RELATED APPLICATIONS

This application claims the priority of European Patent Application, Serial No. EP 08011624, filed Jun. 26, 2008, pursuant to 35 U.S.C. 119(a)-(d), the content of which is incorporated herein by reference in its entirety as if fully set forth herein.

### BACKGROUND OF THE INVENTION

The present invention relates to a method for synchronizing a plurality of drives which are arranged remote from one another, or distributed, and are connected to a supervisory unit via an interface and a communication medium.

The following discussion of related art is provided to assist the reader in understanding the advantages of the invention, and is not to be construed as an admission that this related art is prior art to this invention.

A method for synchronizing a plurality of drives and drives which can be operated with such method are known in the art. Simple automated machines with a plurality of drives are frequently operated by conventional stepper drives connected to a pulse direction interface by a supervisory controller mentioned here as an example of a supervisory device. Examples of such machines are machine tools and the like. The drives of machine tools as well as of other applications must operate as synchronously as possible. Typical stepper drives without their own clock continuously follow the pulse direction setpoint values or phase-shifted signals, known also as A-B signals, the phase angle of which is used to ascertain the direction, so that synchronicity is implicitly obtained. However, stepper drives are increasingly replaced by servo-drives which, however, are still operated on a pulse direction interface or the like. These drives are therefore also referred to as semi-servo-drives. However, these drives with internal digital regulation have dedicated clocking, and different drives in a machine may therefore not be synchronized with each other. This can result in a shift in the clocking of the individual semi-servo-drives and, in the case of machine tools, for example, may cause contour discrepancies and the like.

Traditional drives, specifically the aforementioned stepper drives, operate effectively in an analog mode, so that such clock shifting and any resultant contour discrepancies do not occur. With drives having a digital drive bus, special, and often complex measures are taken in order to achieve synchronicity between several drives. One example of such special measures, which may also include additional hardware, is an electronic circuit for clock synchronization (PLL) or a telegram sent for synchronization purposes (control telegram).

Semi-servo-drives are controlled by a continuous pulse stream for each position controller clock. All setpoint value increments for a drive (an axle of the respective machine) are outputted successively at a position controller clock with constant time intervals. No synchronization takes place between the drives. Although due to the continuous pulse stream, the error resulting from the lack of synchronization between the drives is smaller than for a purely digital drive bus with a constant setpoint value for each position controller clock, the contour accuracy can also be improved for a semi-servo-drive with synchronization.

It would therefore be desirable and advantageous to obviate prior art shortcomings by providing an improved method and device for synchronizing the operation of several remote drives.

### SUMMARY OF THE INVENTION

According to one aspect of the present invention, a method for synchronizing a plurality of drives which are arranged remotely from one another and are connected to a supervisory unit via an interface having an interface with at least one activation input, includes the steps of transmitting for a predetermined duration to the at least one activation input a predetermined status, interpreting a change to the predetermined status at the activation input as a start signal for starting synchronization of a drive, if the predetermined duration is less than a threshold value, and activating or deactivating the drive, if a change to the predetermined status at the activation input has a duration greater than the threshold value.

In this case, the predetermined period during which a predetermined status is impressed on the activation input for triggering the synchronization is below a threshold value, and a status of the activation input that lasts longer than a period expressed by the threshold value is evaluated for activating or deactivating the drive. It can thereby be guaranteed that one and the same activation input of the interface can be used to handle both functionalities, namely synchronization, on the one hand, and activation and deactivation of the drive, on the other hand.

The advantage of the invention is therefore that an input which is included anyway in the interface which is used to make the communicative connection for the drives is used for synchronization, without the functionality for which this input was provided before, i.e. activation or deactivation of the drive, no longer being available. Whereas a permanent change of status for the activation input is thus provided for activation or deactivation of the drive, for example, it is possible for a brief change of status to be impressed on the same input for synchronization, the change of status can then be used directly as the starting point for the synchronization. This approach for synchronizing a plurality of drives can be implemented easily and without additional equipment complexity. In particular, it avoids alternative options for synchronizing a plurality of drives which presuppose the use of an additional line (clock line).

According to another aspect of the invention, a drive for synchronizing remote drives, includes an interface having at least one activation input for activating or deactivating the drive, with the interface providing connectivity with other drives and with a supervisory unit, and evaluation means for evaluating a duration of a predetermined status at the at least one activation input. The evaluation means produce, during operation of the drive, a synchronization signal if the duration of the predetermined status is less than a predetermined threshold value, and said evaluation means producing, during operation of the drive, a special signal if the predetermined status at the activation input has a duration greater than the threshold value.

A drive in this form can thus evaluate data transmitted via the interface and statuses present at the activation input of said drive, specifically in respect of the period during which a particular, predetermined, status is present. As soon as such a status appears at the activation input, a synchronization signal is produced. If the status is present only for a short time, there is no further reaction to the state of the activation input. The synchronization signal triggers the synchronization operation internally in the drive. If the status is present for longer than a period encoded by the threshold value, it is evaluated as a signal for activating or deactivating the drive, and accordingly a special signal is generated. If the aim is to ensure that, when the activation or deactivation of the drive needs to be triggered via the activation input, no synchronization signal is produced, then it is possible to provide for the synchronization signal to be produced only when the status of the activation input changes back from a predetermined status again and when this change takes place within a period which is below the predetermined threshold value. The end of the pulse is thus evaluated, whereas the solution described first involves the synchronization signal actually being triggered on the basis of the first edge, i.e. at the start of the pulse.

Advantageous embodiments of the invention may include one or more of the following features.

According to another advantageous feature of the present invention, the predetermined period during which a predetermined status is impressed on the activation input for triggering the synchronization can be below a threshold value, and a status of the activation input that is present for longer than a period expressed by the threshold value can be evaluated for activating or deactivating the drive. There is then the assurance that one and the same activation input of the interface can be used to handle both functionalities, namely synchronization, on the one hand, and activation and deactivation of the drive, on the other hand.

If the synchronization signal can be evaluated in the drive internally as a starting signal for synchronization purposes, it is possible to modularize the relevant functionality of the drive to the extent that the synchronization signal can be routed to a functionality included by the drive for synchronization purposes, on the one hand, from the previously described evaluation means or that, when the drive has an additional line added for synchronization purposes, the synchronization signal can be generated using the status of this line.

According to another advantageous feature of the present invention, the evaluation means may be an electronic circuit which performs the individual method steps under program control, so that the invention also relates to a computer program having computer-executable program code instructions such that an electric circuit representing the evaluation means, for example, continuously monitors the status of the activation input, that the synchronization signal is produced when said activation input changes status to a predetermined status, for example, and that the special signal is generated when this status is present for long than a predetermined period. To this extent, the invention also relates to a storage medium, e.g. an EPROM or the like, or, if the implementation of the invention in the form of a computer program actually comprises microcode instructions instead of program code instructions, also relates to an ASIC, an FPGA or the like with a computer program of this kind and to a computer system on which such a computer program is loaded, particularly to a drive having an evaluation means of this kind or to a supervisory unit for actuating a plurality of drives which is provided in order to output a signal of predetermined period at the activation input of the respective drives to be actuated for synchronizing said drives, wherein, when provision is made for the respective drive to be activated or deactivated, a signal is output which has a period which safely exceeds a threshold value.

According to yet another aspect of the invention, a computer program having computer-executable program code instructions and embodied in a computer-readable medium is provided, with the program code instructions, when executed on a computer, causing the computer to synchronize a plurality of drives which are arranged remotely from one another and are connected to a supervisory unit via an interface having an interface with at least one activation input, by transmitting for a predetermined duration to the at least one activation input a predetermined status, interpreting a change to the predetermined status at the activation input as a start signal for starting synchronization of a drive, if the predetermined duration is less than a threshold value, and activating or deactivating the drive, if a change to the predetermined status at the activation input has a duration greater than the threshold value. A storage medium having a computer program with computer-executable program code instructions for carrying out the method of the invention is also envisioned.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematically simplified illustration of a machine tool having a plurality of synchronously actuatable drives

FIG. 2 shows an illustration of a time profile for a signal for actuating the drives, and

FIG. 3 shows a simplified schematic diagram of a functionality of a drive, as proposed in line with the invention for synchronizing said drive to other drives.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

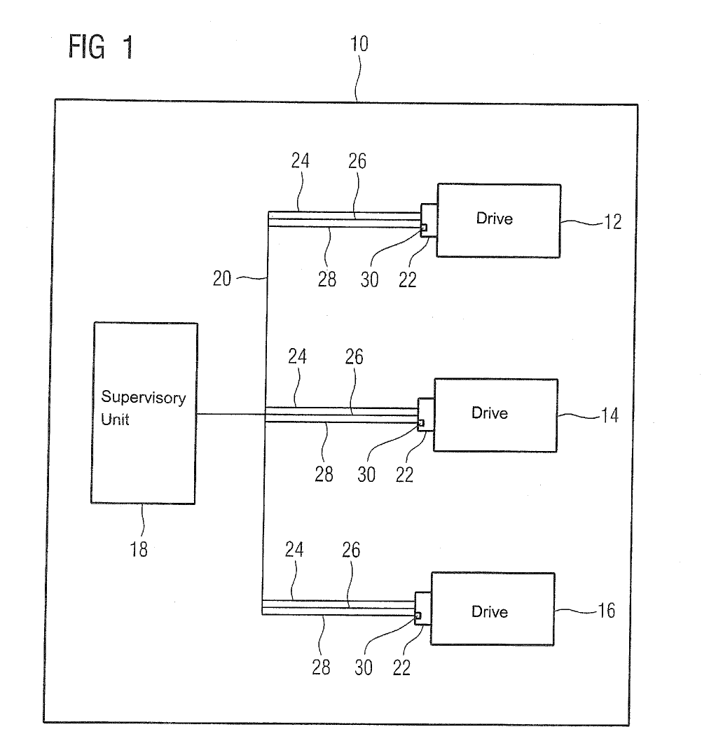

Turning now to the drawing, and in particular to FIG. 1, there is shown a schematic diagram of an exemplary machine tool 10 for use with an application where a plurality of drives 12, 14, 16 need to be synchronized. The drives 12-16 are connected to one another and to a supervisory unit 18, for example, a control device for the machine tool 10, via a communication medium 20, with a respective interface 22 being provided for connecting the communication medium 20 to the respective drive 12-16. The drives 12-16 are servo drives, and the interface 22 is a pulse direction interface, i.e. an interface in which, for each transmitted voltage pulse, the respective drive 12-16 advances by exactly one increment. The pulse direction interface will hereinafter also form the basis for other similar interfaces, e.g. an interface with A-B signals. In this case, the direction of rotation is determined by a second line included by the communication medium 20. In addition, the communication medium 20 includes a line for activating or deactivating the respective drive 12-16, which is subsequently referred to as Enable line, for short. The communication medium 20 thus includes at least three lines, namely a pulse line 24, a direction line 26 and an Enable line 28. For connecting the lines 24-28, the interface 22 includes a respective input, the connection for the Enable line 28 subsequently being referred to as activation input 30.

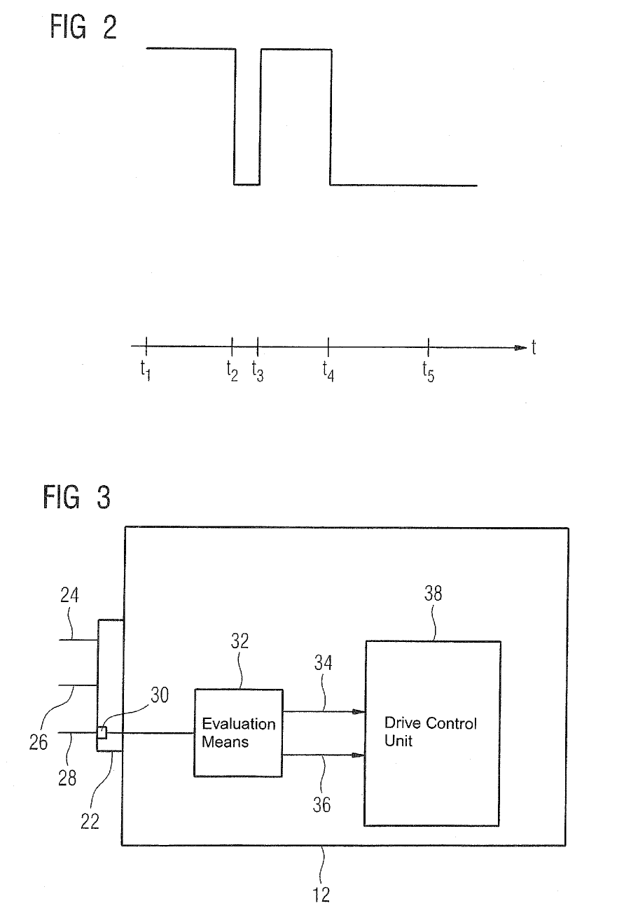

FIG. 2 shows by way of example different states of the activation input 30 (FIG. 1) over a time axis “t”. Since the activation input 30 is basically provided for activating or deactivating the respective drive 12-16, there is at least one quiescent status (e.g. High) which is normally present at the activation input 30 (time period t₁ to t₂). For synchronizing a respective drive 12-16 to other, associated drives 12-16, i.e., the remaining drives in the same machine 10 or the remaining drives for the same motion sequence/mode, for example, a predetermined status, i.e., a status other than the quiescent status, is impressed on the activation input 30 of the respective drive 12-16, normally all the drives 12-16 or at least drive groups included by a machine 10, for a predetermined period (shown in FIG. 2 for the time period t₂ to t₃). The drive evaluates the change in the status of the activation input 30 as a starting signal for synchronization purposes. The duration during which the predetermined status is impressed on the activation input 30 for synchronization purposes is less a predetermined threshold value, and a status of the activation input 30 that is present for longer than a duration expressed by the threshold value is evaluated for activating or deactivating the drive 12-16 (shown in FIG. 2 for the time period t₄ to t₅ and onward), with the time interval between t₅ and t₄ may be considered as a graphical representation of the threshold value.

FIG. 3 shows further details concerning a drive 12-16 which can be synchronized in this manner. Accordingly, the drive 12 includes an evaluation means 32 which monitors the status of the activation input 30. Specifically, this monitoring of the activation input 30 includes evaluation of a duration of a predetermined status of the activation input 30. When such predetermined status is present and more specifically, when this status is present for a duration, the evaluation means 32 produces during operation a synchronization signal 34 or a special signal 36. The synchronization signal 34 can be produced as soon as the activation input 30 assumes the predetermined status (for example, in the illustration in FIG. 2 approximately at the time t₂) or when it is certain that the predetermined status is present for a duration that is no longer than the threshold value (for example, in the illustration of FIG. 2 approximately at the time t₃). Conversely, the special signal 36 is produced when the predetermined status is present for longer than a duration encoded by the threshold value (for example, in the illustration of FIG. 2 approximately at the time t₅).

The synchronization signal 34 and the special signal 36 are evaluated within the drive 12, e.g. by a drive control unit 38, with the synchronization signal 34 being evaluated for synchronization purposes and the special signal 36 being evaluated for activating or deactivating the drive.

In summary, the present invention can therefore be described as follows: to avoid contour discrepancies when using several drives 12-16 and to also limit the level of complexity required for synchronization, it is proposed that a line which is in any case required for actuating a drive 12-16, e.g. the Enable line 28, be additionally used for sending a clock pulse synchronously to a plurality of coordinated drives 12-16 as “slaves”. Such a clock pulse, i.e. the synchronization signal 34, can be used for synchronization by any drive 12-16, with for example software PLL provided for this purpose. The clock pulse, i.e., the change of status of the activation input 30, needs to occur synchronously with the position controller clock provided by the supervisory unit 18 and must only have a short defined length. The drives 12-16 should be designed so as to recognize a pulse of the defined length as a clock pulse and evaluate a longer pulse, i.e., a longer switch-off duration of the Drive Enable signal, as a removal of the Drive Enable, corresponding to a deactivation of the respective drive 12-16.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed is:

1. A method for synchronizing a plurality of drives which are arranged remotely from one another and are connected to a supervisory unit via an interface having an interface with at least one activation input, comprising the steps of:
transmitting for a predetermined duration to the at least one activation input a predetermined status,
interpreting a change to the predetermined status at the activation input as a start signal for starting synchronization of a drive, if the predetermined duration is less than a threshold value, and
activating or deactivating the drive, if a change to the predetermined status at the activation input has a duration greater than the threshold value.

2. A drive, comprising:
an interface having at least one activation input for activating or deactivating the drive, said interface providing connectivity with other drives and with a supervisory unit, and
evaluation means for evaluating a duration of a predetermined status at the at least one activation input,
said evaluation means producing, during operation of the drive, a synchronization signal if the duration of the predetermined status is less than a predetermined threshold value, and said evaluation means producing, during operation of the drive, a special signal if the predetermined status at the activation input has a duration greater than the threshold value.

3. The drive of claim 2, wherein the synchronization signal is evaluated internally in the drive as a start signal for starting synchronization of the drive.

4. A computer program having computer-executable program code instructions embodied in a computer-readable medium, with the program code instructions, when executed on a computer, causing the computer to synchronize a plurality of drives which are arranged remotely from one another and are connected to a supervisory unit via an interface having an interface with at least one activation input, by:
transmitting for a predetermined duration to the at least one activation input a predetermined status,
interpreting a change to the predetermined status at the activation input as a start signal for starting synchronization of a drive, if the predetermined duration is less than a threshold value, and
activating or deactivating the drive, if a change to the predetermined status at the activation input has a duration greater than the threshold value.

5. A storage medium having a computer program with computer-executable program code instructions as claimed in claim 4.
